(19) United States
(12) Patent Application Publication
(10) Pub. No.: US 2013/0135700 A1
(43) Pub. Date: May 30, 2013

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Hirokazu Tamura, Kawasaki-shi (JP)

(73) Assignee: CANON KABUSHIKI KAISHA, Tokyo (JP)

(21) Appl. No.: 13/669,927

(22) Filed: Nov. 6, 2012

(30) Foreign Application Priority Data
Nov. 30, 2011 (JP) 2011-262211

(51) Int. Cl. H04N 1/46; H04N 1/40

(52) U.S. Cl. 358/530; 358/448

(57) ABSTRACT

In an image processing apparatus having a first reading unit to read a front-face image of an original which is conveyed and a second reading unit to read a back-face image of the original which is conveyed, image processing parameters for eliminating the back-face image which is projected as a show-through image to the front-face image of the original which is displayed to a displaying unit are input. An image process according to each of the input image processing parameters is executed to image data of the front-face. The image data displayed to the displaying unit is switched to the image-processed image data of the front-face.

### BACKGROUND OF THE INVENTION

1. Field of the Invention

The present invention relates to an image processing apparatus for eliminating a show-through image.

2. Description of the Related Art

In the related arts, in an image processing apparatus having an image reading apparatus represented by a scanner, a facsimile apparatus, or a copying apparatus, when an image is read out of an original, a front-face image and a back-face image of the original can be automatically obtained by using an ADF (Auto Document Feeder) or the like.

By such a method, the user doesn't need to especially put a duplex-printed original (original in which images have been printed on both front and back surfaces) onto a copyboard twice by respectively putting its front-face and back-face thereon, so that a user's burden for obtaining images of the duplex-printed original is reduced.

In recent years, two kinds of image sensors such as sensor for reading a front-face image and sensor for reading a back-face image are provided in one reading apparatus, thereby enabling the front-face image and the back-face image of the original to be apparently simultaneously obtained by the reading operation of one time.

However, in such an image reading apparatus in the related arts, in the case where the duplex-printed original was read, the back-face image is pierced and seen through the front-face image due to a sheet thickness of the original, a quantity of light which enters the image sensor, and the like, so that it results in a cause of losing quality of a read image.

In the related arts, some trials to those problems of the show-through image of the original have been made. As typical countermeasures, there is such a process that an image obtained by mirror-image reversing the back-face image is subtracted from the front-face image, thereby eliminating an influence of the back-face image from the front-face image, or the like.

According to Japanese Patent Application Laid-Open No. H08-265563, a show-through image is reduced by such a process that an influence of the back-face image on the front-face image is eliminated by an addition of the front-face image and the back-face image.

According to Japanese Patent Application Laid-Open No. H05-63968, a ground level of an original is discriminated by prescanning and pixels of a luminance higher than that of the calculated ground level are efficiently deleted. At this time, although a device which does not lose a color reproducibility of the original is performed by an arithmetic expression, a projection of the back-face image is not considered and a show-through image cannot be deleted from the ground of the original in which the show-through image often occurs.

However, in order to execute a synthesizing process as mentioned above, a precision of registration between the front-face image and the back-face image of the original is very important.

For example, if a registration position of the front and back faces, that is a coordinate position (of the back-face image) corresponding to the front-face image is deviated by 200 μm, such a deviation corresponds to a deviation of about 5 pixels in an image which was read at a resolution of 600 dpi.

Therefore, when a subtraction synthesization of the original which was deviated by 5 pixels is executed, there is a case where the subtraction synthesization contrarily causes the registration precision to be deteriorated. A point that the registration precision of the reading device is raised is an indispensable requirement. When the registration precision is low, the subtraction synthesization is newly performed to a portion where the back-face image is not inherently projected, so that a shadow of a show-through image is produced.

### SUMMARY OF THE INVENTION

The invention is made to solve the above-described problems and it is an aspect of the invention to provide such a mechanism that an image regarding a second face is desirably eliminated from image data regarding a first face, thereby enabling the user to obtain a desired image.

To accomplish the above object, according to the invention, there is provided an image processing apparatus comprising: a first reading unit configured to read a first face of an original and generate first image data; a second reading unit configured to read a second face of the original and generate second image data; a receiving unit configured to receive an input of the user of an image processing parameter for eliminating an image regarding the second face from the first image data; and an image processing unit configured to execute an image process for eliminating the image regarding the second face from the first image data on the basis of the image processing parameter received by the receiving unit and the second image data.

Further features of the present invention will become apparent from the following description of exemplary embodiments with reference to the attached drawings.

### BRIEF DESCRIPTION OF THE DRAWINGS

FIG. 1 is a cross sectional view for describing a construction of an image processing apparatus showing an embodiment.

FIG. 2 is a cross sectional view for describing the construction of the image processing apparatus showing the embodiment.

FIG. 3 is a block diagram for describing a control construction of the image processing apparatus illustrated in FIG. 2.

FIG. 4 is a flowchart for describing an image processing method of the image processing apparatus.

FIGS. 5A, 5B and 5C are diagrams for describing images read by reading devices.

FIG. 6 is a plan view for describing a construction of an operation unit illustrated in FIG. 3.

FIGS. 7A, 7B, 7C, 7D and 7E are diagrams for describing the back-face eliminating process in the image processing apparatus.

FIG. 8 is a flowchart for describing the image processing method of the image processing apparatus.

FIGS. 9A, 9B, 9C, 9D and 9E are diagrams for describing a state of an original to be read by the image processing apparatus.

FIGS. 10A and 10B are block diagrams for describing the construction of the image processing apparatus showing the embodiment.

FIG. 11 is a diagram for describing an image process of the image processing apparatus showing the embodiment.

### DESCRIPTION OF THE EMBODIMENTS

Preferred embodiments of the present invention will now be described in detail in accordance with the accompanying drawings.

### Description of System Construction

### First Embodiment

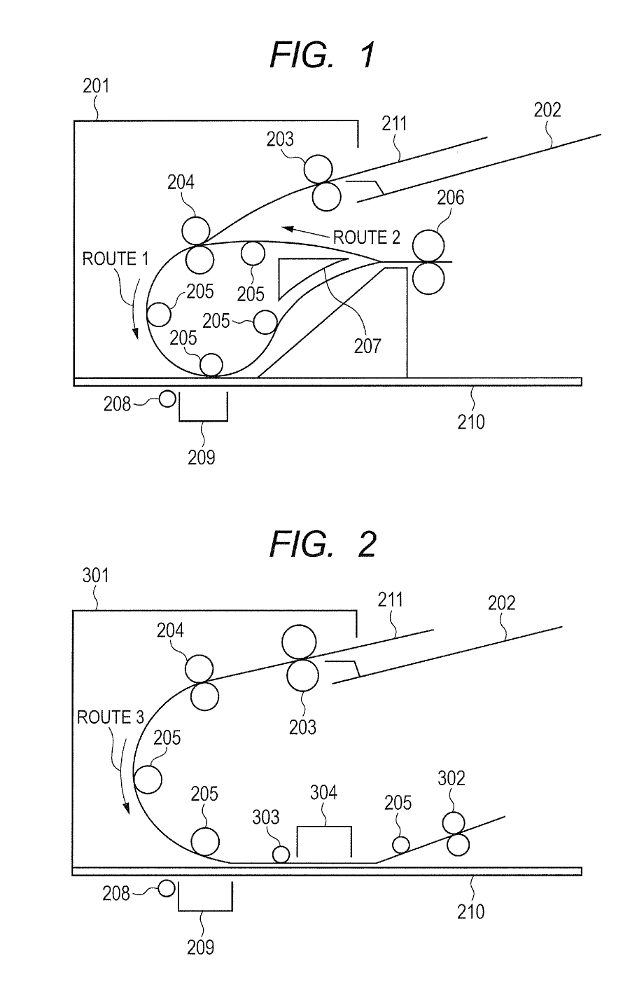

FIGS. 1 and 2 are cross sectional views for describing a construction of an image processing apparatus showing an embodiment. The diagrams illustrate an example of the image processing apparatus in which an image reading apparatus such as copying apparatus, facsimile apparatus, scanner for inputting to a computer, or the like is used as a unit for electronically reading information of an original on which the information has been written.

In FIG. 1, an original copyboard 202, a pickup roller 203, a conveying roller 204, rollers 205, a reverse conveying/delivery roller 206, a separating claw 207, a light source 208, a reading unit 209, copyboard glass 210, and an original 211 are illustrated.

The original 211 put on an automatic duplex reading apparatus 201 is sent one by one to a reading path by the pickup roller 203. The original which was sent one by one to the reading path by the pickup roller 203 is conveyed through the conveying roller 204 in the direction of a path 1 illustrated in the diagram. The light source 208 is provided for the reading unit 209. The light source 208 has a spectral intensity with respect to a wavelength area of about a visible light area.

The original which had passed through the path 1 and reached a reading position is irradiated by the light source 208 and light reflected by the original enters the reading unit 209. The reading unit 209 has at least a photoelectric conversion element, stores electric charges corresponding to the intensity of the incident light, and converts them into digital data by an A/D converter (not shown), thereby converting the image information on the original into digital image data. The intensity of the light which enters the reading unit 209 depends on distribution of a spectral reflectance included in the information on the original.

Image information added on the front-face of the original 211 which had passed through the path 1 and reached the reading position is read by the light source 208 and the reading unit 209.

After that, the original 211 arrives at the reverse conveying/delivery roller 206 and is temporarily delivered to a rear edge of the original. After that, the reverse conveying/delivery roller 206 reverses a rotation thereof and fetches the original 211 again to the automatic duplex reading apparatus 201. The original 211 is guided in the direction of a path 2 by the separating claw 207 and passes again along the path 1 by the conveying roller 204. Image information added on the back-face of the original 211 is read at the image reading position by the light source 208 and the reading unit 209. After that, the original 211 is delivered by the reverse conveying/delivery roller 206.

By repeating the foregoing operation, the image information of the front-face images and the back-face images of a group of originals put on the original copyboard 202 is sequentially read.

In the case where the image information written on the front-face and the back-face of the original is read by such an automatic duplex reading apparatus, the front-face image and the back-face image of the original can be automatically read without an intervention of the user. Further, according to the automatic duplex reading apparatus, the front-face and back-face images are read by the single light source and reading unit and an apparatus of its optical system is a single apparatus.

Therefore, in the automatic duplex reading apparatus, geometrical characteristics and characteristics such as coloring and the like of the front-face read image and those of the back-face read image are identical. On the other hand, in the automatic duplex reading apparatus, since the original is conveyed in the automatic duplex reading apparatus when the front-face image is read and when the back-face image is read, it takes a time to read the images. Further, since the conveyance of the original by the automatic duplex reading apparatus is complicated, a probability of a sheet jam rises.

On the other hand, in a reading unit 101 having another construction, a simultaneous duplex reading apparatus 301 in which a front-face image and a back-face image of an original in which information has been written on a front-face and a back-face are simultaneously read by a conveyance of one time is illustrated in FIG. 2.

In FIG. 2, a delivery roller 302, a light source 303, and a reading unit 304 are illustrated and other portions having substantially the same functions as those in the automatic duplex reading apparatus are designated by the same reference numerals as those in FIG. 2. In this example, in order to read both faces of the original by the conveyance of one time, original reading units are arranged at predetermined positions at a predetermined interval. Particularly, in this example, the reading unit to read the back-face side is arranged on a downstream side of the reading unit to read the front-face side.

In FIG. 2, the original 211 put on the original copyboard 202 is conveyed one by one to the reading path by the pickup roller 203. The picked-up original 211 is conveyed in the direction of a path 3 through the conveying roller 204. The original 211 passes through the path 3 and reaches a reading position and image information added on the front-face of the original 211 is read out by the light source 208 and the reading unit 209. After that, when the original 211 reaches the reading position of the reading unit 304, the image information on the back-face of the original 211 is read by the light source 303 and the reading unit 304. After that, the original 211 is delivered by the delivery roller 302.

By repeating the above-described operation, the information of the front-face images and the back-face images of the group of originals put on the original copyboard 202 is read by the conveyance of one time.

In the case where the image information written on the front-face and the back-face of the original is read by such a simultaneous duplex reading apparatus, the front-face image and the back-face image of the original can be automatically read without an intervention of the user. Further, the simultaneous duplex reading apparatus can simultaneously read the information of the front-face image and the back-face image by the conveyance of the original of one time.

Therefore, the simultaneous duplex reading apparatus can reduce the time which is required to read the images and improve performance as a reading apparatus. Further, the simultaneous duplex reading apparatus can reduce the probability of the jam because it is sufficient to convey the original along one path. In the simultaneous duplex reading apparatus, as shown in the light source 208 and the light source 303 and in the reading unit 209 and the reading unit 304, the image reading devices for reading the front-face and the image reading devices for reading the back-face are arranged, respectively.

Hereinbelow, a combination of the light source 208 and the reading unit 209 is called a first reading unit, and a combination of the light source 303 and the reading unit 304 is called a second reading unit.

For example, the first reading unit is arranged on a lower surface side of the copyboard glass 210. When the original 211 is put onto the copyboard glass 210, the first reading unit itself can also read the original while moving in the sub-scanning direction of the original.

By using the reading apparatus as mentioned above, the information of both of the front-face image and the back-face image of the original printed on both surfaces thereof can be obtained.

When the front-face image and the back-face image of the original are read, they are subjected to image processes such as γ correction, space filter, and the like and, thereafter, they are temporarily spooled into a recording medium such as an HDD or the like. After that, image processes are executed and the resultant images are printed out by a printer, displayed to a displaying unit, or transmitted to a network.

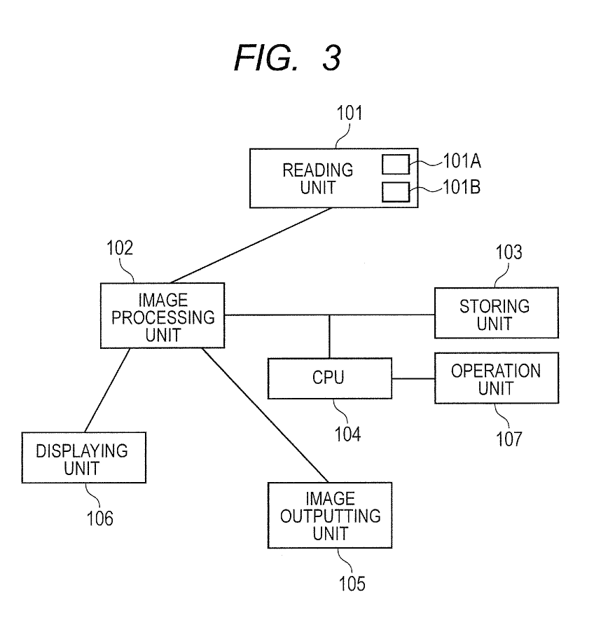

FIG. 3 is a block diagram for describing a control construction of the image processing apparatus illustrated in FIG. 2. This example relates to an image processing apparatus for reading images of a duplex original and executing image processes. Particularly, as shown in the image processing apparatus illustrated in FIG. 2, the apparatus has the first reading unit for reading the front-face image of the original which is conveyed and the second reading unit for reading the back-face image of the original which is conveyed.

In FIG. 3, the image processing apparatus has the reading unit 101, an image processing unit 102, a storing unit 103, a CPU 104, an image outputting unit 105, a displaying unit 106, and an operation unit 107. The image processing apparatus can be connected through a network or the like to a server for managing the image data, a personal computer (PC) for instructing an execution of printing, or the like. The reading unit 101 reads the images of the original and outputs image data. A hardware construction of the reading unit 101 reads the original which is conveyed by the conveying paths and the conveying method illustrated in FIGS. 1 and 2. The reading unit 101 has: a reading device 101A constructed as a first reading unit in which the light source 208 and the reading unit 209 are combined; and a reading device 101B constructed as a second reading unit in which the light source 303 and the reading unit 304 are combined.

The image processing unit 102 converts print information including the image data which is input from the reading unit 101 or an outside into intermediate information (hereinbelow, called an “object”) and stores into an object buffer in the storing unit 103. At this time, image processes such as ground color elimination, show-through image elimination, and the like are executed. Further, bit map data is generated on the basis of the buffered object and stored into the buffer in the storing unit 103. At this time, image processes such as ground color eliminating process, show-through image eliminating process, and the like are executed. Details will be described hereinafter.

The storing unit 103 is constructed by a ROM, a RAM, a hard disk (HD), or the like. Various kinds of control programs and image processing program which are executed by the CPU 104 have been stored in the ROM. The RAM is used as a referring area or a work area into which the CPU 104 stores data and various kinds of information. The RAM and the HD are used for the object buffer mentioned above or the like.

In the RAM and the HD, the image data is stored, pages are sorted, the data of the original constructed by a plurality of sorted pages is stored, and a process for printing out a plurality of print copies or the like is executed.

The image outputting unit 105 forms a color image onto a recording medium such as recording paper or the like or outputs image data to the outside by using a network.

The displaying unit 106 displays a result of the processes executed in the image processing unit 102 and performs a confirmation and the like of a preview result of the image obtained after the image processes.

In the operation unit 107, operations such as setting of the number of copy prints and a duplex copying mode, original setting about whether a color copy is performed or a monochromatic copy is performed and the like, adjustment setting about the ground color and the show-through image elimination, and the like are executed.

As for the reading unit 101, a method whereby the front-face and the back-face of the original are reversed by the original reversing unit is most widely implemented as an automatic duplex reading apparatus for automatically reading the image information of the front-face image and the back-face image of the original without an intervention of the user and has been put into practical use.

The automatic duplex reading apparatus using such an original reversing unit is shown at 201 in FIG. 1.

In the embodiment, a case of reading a color original as color image data will be described unless otherwise specified.

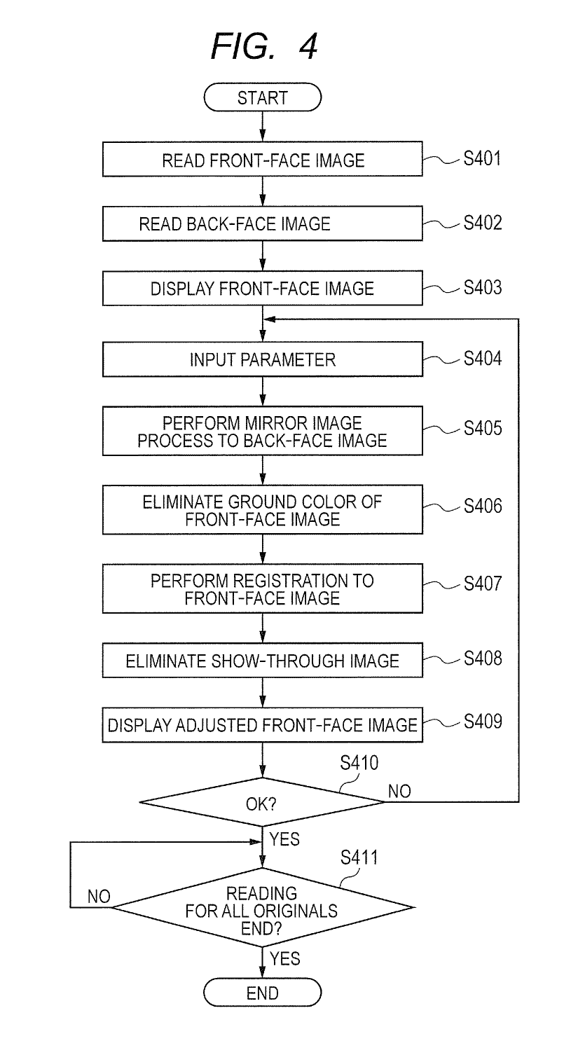

FIG. 4 is a flowchart for describing an image processing method of the image processing apparatus showing the embodiment. In this example, two image reading units are arranged on the conveying path at a predetermined interval as illustrated in FIG. 2, and while the front-face image and the back-face image of the original which is conveyed are read in parallel, the show-through image to the front-face by the image on the back-face side is eliminated. Each processing step is executed by the reading unit 101 and the image processing unit 102 on the basis of commands from the CPU 104. Such a display image adjusting process that by executing the image processes to the image data which causes a show-through, the image is switched to an adjusted image in which the image data of the back-face which forms a show-through image to the image data of the front-face has been eliminated will be described hereinbelow.

It is now assumed that a plurality of originals were put onto the original copyboard 202. When an instruction to execute the reading is input from the user by an execution button or the like (not shown), the reading unit 101 reads the first original. In S401, the image information of the front-face of the original which is conveyed along the path 1 on the conveying path is obtained by the reading device 101A of the reading unit 101. Similarly, in S402, the image information of the back-face of the original which is conveyed is obtained by the reading device 101B. The image information of the back-face is obtained with a delay of a predetermined time than the timing when the image information of the front-face has been obtained.

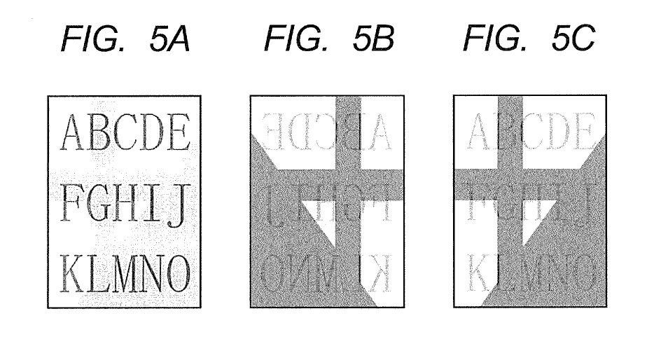

FIGS. 5A, 5B, and 5C are diagrams for describing the images which were read by the reading devices 101A and 101B illustrated in FIG. 3. FIG. 5A illustrates an example of the front-face image and FIG. 5B illustrates an example of the back-face image. As illustrated in those diagrams, the image in which the back-face image is pierced and seen through the front-face image and, contrarily, the image in which the front-face image is pierced and seen through the back-face image are obtained by the reading devices 101A and 101B in S401 and S402. Each image in this instance is obtained as a digital image signal having 256 gradations per pixel of RGB. The pixel which is dark on the image and is close to black indicates a small pixel value. On the contrary, the pixel which is bright on the image and is close to white indicates a large pixel value. The obtained images are temporarily stored into the storing unit 103 so as to be used for the subsequent processes. In S403, the CPU 104 allows the front-face image which causes a show-through to be displayed to the displaying unit 106. Subsequently, in S404, an input of parameters of different attributes to eliminate an influence of the show-through image from the user is received.

Subsequently, in S405, the image processing unit 102 executes a process for mirror-image reversing the back-face image so as to match with the direction of the front-face image. Since the back-face image to the front-face image has certainly been mirror-image reversed, such a process is executed to match them. A result of such a process is illustrated in FIG. 5C.

Subsequently, in S406, the image processing unit 102 executes an image process for eliminating the ground color of a sheet of the front-face image. By this process, a pixel value on the bright side of a highlight portion is set to white, thereby enabling the image to be seen as if the pale color which the sheet ground color has were eliminated. Specifically speaking, such a process can be realized by applying a gain to each pixel of RGB.

For example, assuming that a pixel value of the input is “in”, a pixel value of the output is “out”, and a gain at that time is “a”, such a process can be realized by [out=a×in]. The gain “a” at this time is set on the basis of the display result of the displaying unit 106, which will be described hereinafter, and the input from the operation unit 107 based thereon.

Subsequently, in S407, the image processing unit 102 decides a coordinate position of the back-face image to the front-face image. After front edges and right and left edges of the front-face image and the back-face image were matched, a registration is performed to the front-face image.

That is, when coordinates of the pixel existing on the front-face are (x, y), coordinates of the back-face image to be referred to are (x+Δx, y+Δy). A deviation Δx and Δy of the coordinate position of the back-face image to the front-face image is set on the basis of the inputs from the displaying unit 106 and the operation unit 107, which will be described hereinafter.

Subsequently, in S408, the image processing unit 102 eliminates an influence of the back-face image from the front-face image. By this process, a component of the back-face image which is pierced and seen through the front-face image is eliminated.

At this time, a portion in which the back-face image is dense (dark) exerts a large influence on the front-face. On the contrary, a portion in which the back-face image is thin (bright) exerts a small influence on the front-face.

That is, the influence when the back-face is white (pixel value is equal to 255) is minimum and the influence when the back-face is black (pixel value is equal to 0) is maximum. In other words, there is such a relation that a degree of influence is opposite to the pixel value of the back-face image. The degree of influence can be defined by a value of (255−pixel value).

A value obtained by multiplying the degree of influence by the gain using a piercing degree as a coefficient is applied as an offset to the pixel value of the front-face, thereby enabling the influence by the back-face image to be reduced.

Such a gain is a coefficient which is equal to “1” when the back-face has perfectly been pierced. The smaller the piercing degree is, a value of gain decreases. The gain is equal to “0” when the back-face is not perfectly pierced. Such a principle is used and, as a specific process, a value obtained by inverting the pixel value of the back-face image is added to the front-face image serving as an input, thereby eliminating the influence.

For example, assuming that the pixel value of the input is set to “in”, the pixel value of the output is set to “out”, the pixel value of the back-face is set to “rev”, and the gain is set to “b”, such a process can be realized by [out=in+(255−rev)×b]. The gain “b” at this time is set on the basis of the inputs from the displaying unit 106 and the operation unit 107.

By executing those processing steps, the front-face image in which the influence of the back-face image has been eliminated is formed. This image is stored into the storing unit 103 and is output from the image outputting unit 105 or, in S409, it is displayed to the displaying unit 106. When the front-face image displayed to the displaying unit 106 is determined, in other words, when the user instructs a button (not shown) and receives an instruction to set a parameter for eliminating the show-through image of the front-face to OK (S410), reading to a plurality of residual originals is started. To the plurality of originals, the parameter may be input again in S404 or the input of the parameter in S404 is omitted and processes similar to those for the first original may be executed. After completion of the reading process of all originals in S411, the present processing routine is finished.

Subsequently, a unit for properly obtaining the values of the gain “a” used in S406 in the foregoing processing flow, Δx and Δy used in S407, and the gain “b” used in S408 by using the displaying unit 106 and the operation unit 107 illustrated in FIG. 3 will be described.

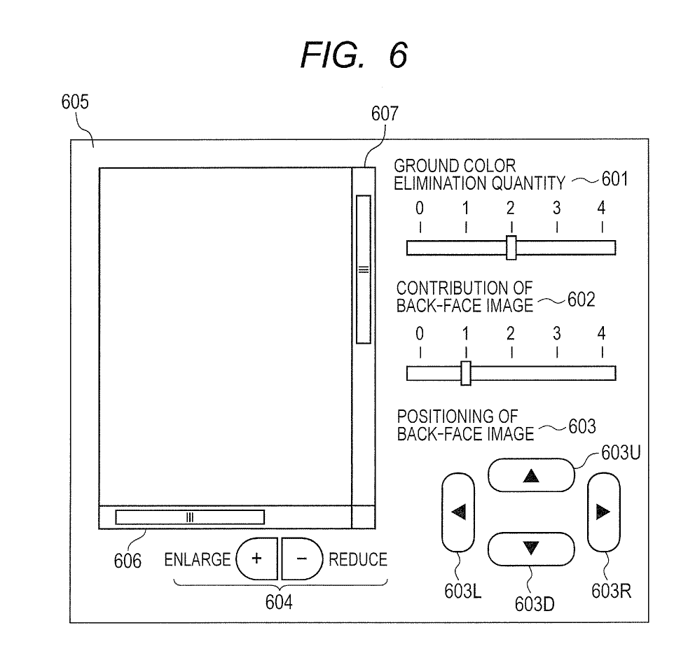

FIG. 6 is a plan view for describing a construction of the operation unit 107 illustrated in FIG. 3. This example shows a case where the operation unit 107 is constructed by a touch panel and each key, bars, and the like are displayed as software buttons. An example of inputting image processing parameters of different attributes adapted to eliminate the influence of the back-face image which is projected as a show-through image to the front-face image of the original will be described hereinbelow. In the embodiment, a bar 601 is provided as a level key for eliminating the ground color of the original. Similarly, a bar 602 is provided as a level key showing a degree of influence of the back-face image. Similarly, keys 603U, 603D, 603L, and 603R are provided as level keys of movement for adjusting the coordinate position of the back-face image. Likewise, a bar 604 is provided as a level key for adjusting a magnification of the back-face image. While confirming the front-face image displayed to a displaying unit 605 and the adjusted image which is displayed, the user operates those keys and inputs the image processing parameters of the different attributes.

In FIG. 6, the bar 601 is used to adjust an elimination quantity of the ground color of the sheet. Assuming that an adjustment value is set to “0”, a mode in which the ground color is not eliminated at all is set and the value of the gain “a” described above in S406 corresponds to 1.0. The gain “a” is adjusted by using the bar 601 and the larger its numerical value is, the value of the gain “a” increases. For example, when the adjustment value is set to “1”, the gain changes to 1.1. When it is set to “2”, the gain changes to 1.2. When it is set to “4”, the gain changes to 1.4, and the like.

The bar 602 is used to adjust a degree of contribution of the back-face image. Assuming that an adjustment value is set to “0”, a mode in which the influence of the back-face image is not eliminated at all is set and the value of the gain “b” described above in S408 corresponds to 0.0. The contribution is adjusted by using the bar 602 and the larger its numerical value is, the value of the gain “b” decreases. For example, when the adjustment value is set to “1”, the gain changes to 0.9. When it is set to “2”, the gain changes to 0.8. When it is set to “4”, the gain changes to 0.6, and the like.

A key 603 to adjust the coordinate position of the back-face image is constructed by four keys 603U, 603D, 603L, and 603R. When the up-key 603U of the key 603 is depressed, the position of the back-face image is moved upward by one pixel and a value of Δy described above in S405 is increased by adding “+1” to an original value of Δy. Similarly, when the down-key 603D is depressed, the value of Δy is decreased by adding “−1” to the original value of Δy. By depressing the left-key 603L, a value of Δx is increased by adding “+1” to an original value of Δx. Similarly, by depressing the right-key 603R, the value of Δx is decreased by adding “−1” to the original value of Δx.

The displaying unit 605 of a resultant image displays the image as a result obtained by executing the processes in S403 to S406 by using the values adjusted by using the bars 601 and 602 and the key 603. That is, the image to which the adjustment results by the bars and the keys have been reflected is displayed to the displaying unit 605.

Specifically speaking, each time the key 603 is depressed and a change in adjustment value occurs, the resultant image obtained by executing the processes in the above steps again to the images obtained and stored in S401 and S402 is displayed. The key 604 is depressed when the image which is displayed to the displaying unit 605 is enlarged or reduced. Scroll bars 606 and 607 are instructed when the image which is displayed is scrolled.

By the ground color eliminating process using the ground color elimination quantity adjusted by the bar 601, the back-face image is also deleted to a certain extent. On the contrary, the ground color of the front-face is also eliminated by the contribution of the back-face image adjusted by the bar 602. In this manner, there is a correlation between them and by feeding back each of the adjustment values while the user watches the resultant image which is displayed to the displaying unit 605, the proper elimination quantity and contribution degree can be obtained.

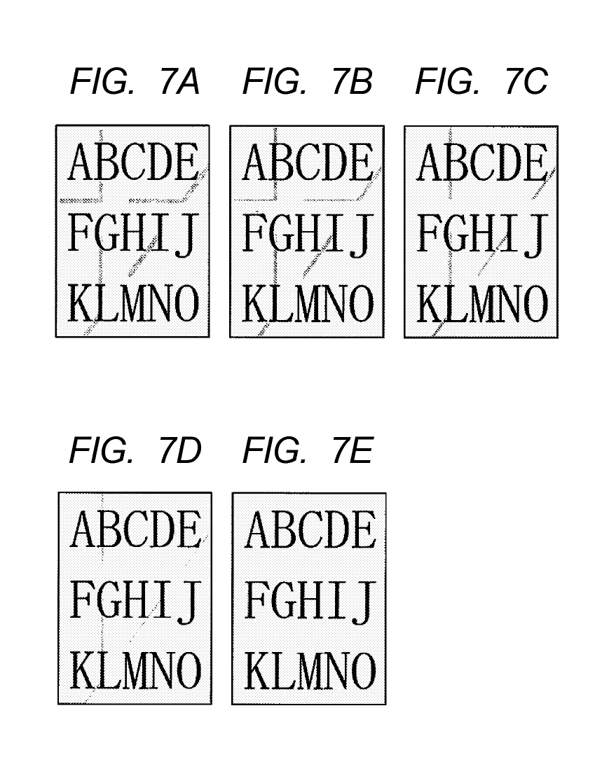

The adjusted images at the coordinate position set by the key 603 will be described in detail with reference to FIGS. 7A, 7B, 7C, 7D, and 7E.

FIGS. 7A to 7E are diagrams for describing the back-face eliminating process in the image processing apparatus showing the embodiment. This example illustrates a state where the user operates the key 603 illustrated in FIG. 6, thereby adjusting image areas on the back-face side and the front-face side and eliminating the show-through image on the back-face side to the front-face side.

For example, it will be understood that when the front-face image as illustrated in FIG. 7A is displayed to the displaying unit 605, since the coordinate position of the back-face is deviated from the front-face, the influence of the back-face is not fully eliminated.

Therefore, when the user depresses the up-key 603U once, the front-face image displayed to the displaying unit 605 changes to a display image as illustrated in FIG. 7B. When the user depresses the up-key 603U again, the front-face image changes to a resultant image as illustrated in FIG. 7C. After the coincidence of the coordinate position in the longitudinal direction was confirmed, by subsequently depressing the left-key 603L, a resultant image as illustrated in FIG. 7D is obtained. By depressing the left-key 603L again, a resultant image in which the influence of the back-face has perfectly been eliminated can be obtained as illustrated in FIG. 7E.

As mentioned above, while observing the resultant images displayed to the displaying unit 605, the proper setting values for eliminating the show-through image, that is, the values of the gain “a” used in S406 in the foregoing processing flow, Δx and Δy used in S407, and the gain “b” used in S408 can be obtained.

The image data which have been processed by using the optimum setting values obtained as mentioned above and have been stored in the storing unit 103 can be printed out from the image outputting unit 105 or transmitted to the network.

Although the embodiment has been described in such a form that both of the front-face image and the back-face image are read in a lump, the invention can be also applied to a case where the front-face image and the back-face image are independently read by using the image processing apparatus using one reading device as illustrated in FIG. 1.

The relation between the front-face image and the back-face image may be reversed. That is, by considering that the back-face image of the original exists on the front-face of the original, the front-face image which is pierced and projected to the back-face image can be also eliminated. In other words, by reversing the relation between the front-face image and the back-face image and processing them, the component of the front-face image which has been pierced and projected to the back-face image can be eliminated.

The example in which from a combination of the front-face image and the back-face image of the one original, the setting values which are optimized to them are adjusted and the processes are executed by using those values has been described so far.

However, since a plurality of originals can be continuously read by the reading unit, it takes much labor to individually perform the adjustment as mentioned above to each of the originals. In the case where such a plurality of originals use the same kind of sheet, the degrees of influence of the back-face or the positional deviations thereof that is caused by thicknesses of sheets or the like are not so largely different. In such a case, it is also possible to use such a construction that the adjustment of the setting values described so far is performed on the basis of the relation of a certain set of front and back faces, the setting values are stored, and they are applied to all of a plurality of originals.

According to the embodiment, even in the reading apparatus whose registration precision is insufficient, the back-face image is desirably eliminated from the front-face image to which the back-face image has been pierced and projected and a desired image of the user can be obtained.

### Second Embodiment

In the foregoing first embodiment, when the show-through image is eliminated, it is a prerequisite condition that the magnification of the front-face image and that of the back-face image coincide perfectly. This is because as described in FIG. 1, although such a perfect coincidence can be expected so long as they are the images which were read by the reading units which are physically identical, when the physically different reading units as described in FIG. 2 are used, the perfect coincidence cannot be expected due to an influence of crossover of lenses, optical paths, sensors, or the like of the reading units. Therefore, in the embodiment, such a construction that the adjustment is made in consideration of the difference between the magnifications of the front and back faces in addition to the setting values used in the foregoing embodiment will be described.

Since a construction of the apparatus using FIGS. 1, 2, and 3 in the second embodiment is also similar to that of the first embodiment, its description is omitted.

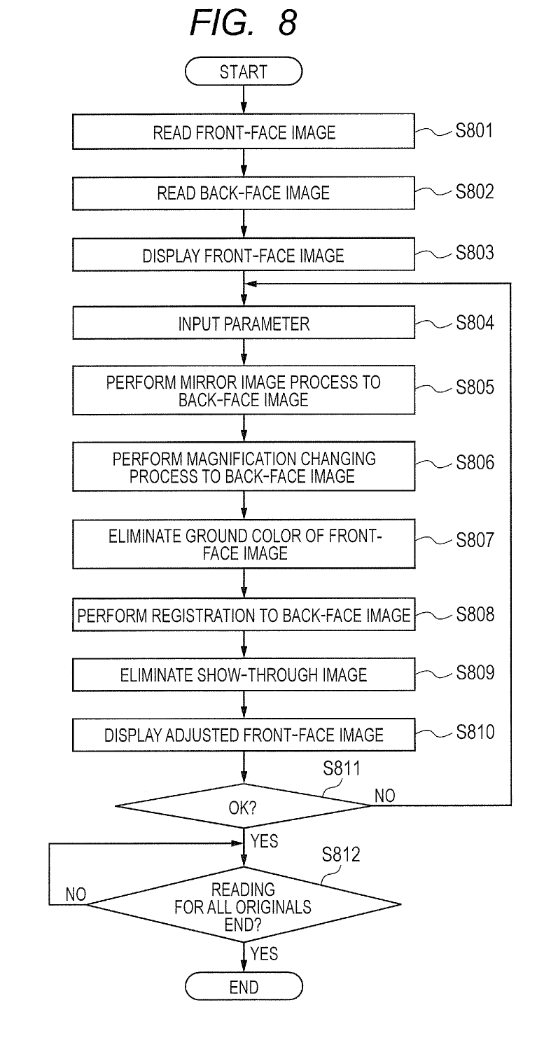

FIG. 8 is a flowchart for describing the image processing method of the image processing apparatus showing the embodiment. In this example, two image reading units are arranged on the conveying path at a predetermined interval as illustrated in FIG. 2, and while the front-face image and the back-face image of the original which is conveyed are read in parallel, the show-through image to the front-face by the image on the back-face side is eliminated. Each processing step is executed by the reading unit 101 and the image processing unit 102 on the basis of the commands from the CPU 104 in a manner similar the processing flow of FIG. 4.

Since a process of S801 is similar to S401 and, likewise, a process of S802 is similar to S402 and a process of S805 is similar to S405, their description is omitted here.

Subsequently, in S806, the image processing unit 102 executes a magnification changing process for making a magnification of the back-face image coincide with that of the front-face image. In this instance, a magnification sx in the landscape direction and a magnification sy in the portrait direction are independently set and the magnification changing process is executed at the different magnifications in the portrait direction and the landscape direction. As an example of the process, a coordinate transformation using a well-known affine transformation and a pixel interpolating process are used. The magnification sx in the landscape direction and the magnification sy in the portrait direction at this time are set on the basis of the inputs from the displaying unit 106 and the operation unit 107, which will be described hereinafter.

Since the subsequent processes in S807, S808, and S809 are respectively similar to those in S406, S407, and S408, their description is omitted here.

By executing those processing steps, even if the magnifications of the front-face image and the back-face image differ, the front-face image in which the influence of the back-face image has been eliminated is formed. This image is stored into the storing unit 103 and is output from the image outputting unit 105. Or, in S810, the CPU 104 allows the image to be displayed to the displaying unit 106. After that, in S811 and S812, processes similar to those in S410 and S411 are executed and the present processing routine is finished.

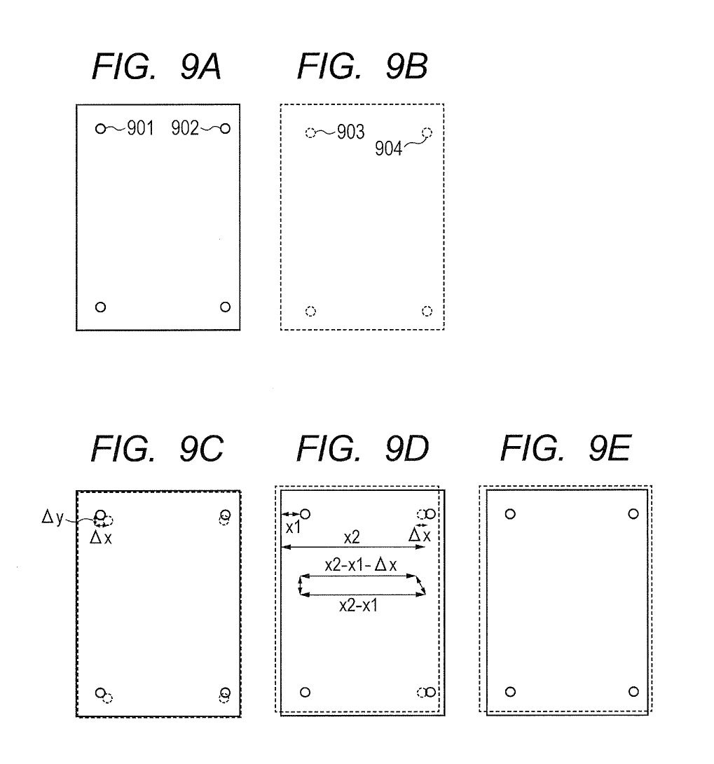

Subsequently, a unit for properly obtaining values of the magnifications sx and sy used in S806 shown in FIG. 8 will be described by using the displaying unit 106 and the operation unit 107 illustrated in FIG. 3 and the front-face image and the back-face image at that time illustrated in FIGS. 9A, 9B, 9C, 9D, and 9E. Since a description about the unit for properly obtaining the value of the gain “a” which is used in S807 shown in FIG. 8 and the value of the gain “b” which is used in S809 is similar to that in the first embodiment, it is omitted here.

FIGS. 9A, 9B, 9C, 9D, and 9E are diagrams for describing a state of an original to be read by the image processing apparatus showing the embodiment.

FIG. 9A illustrates an example of the front-face image obtained in S801 shown in FIG. 8. FIG. 9B illustrates an example of the image obtained by performing the mirror-image reversing process of S805 to the back-face image obtained by S802 at that time.

This example illustrates a state where a circle 901 in the image of FIG. 9A is pierced and seen as a circle 903 in the back-face as illustrated in FIG. 9B and, similarly, a circle 902 in the image of FIG. 9A is pierced and seen as a circle 904 in the back-face as illustrated in FIG. 9B.

First, an enlargement display around the circle 901 as a center is performed by using the key 604 for enlargement and the scroll bars 606 and 607 in FIG. 6. A coordinate position in the landscape direction of the center at this time is held as x1.

Therefore, a coordinate position of the back-face image is shifted by using the key 603 so that the circles 901 and 903 overlap. Δx and Δy suitable for the area around the circle 901 as a center are obtained. Such a state is illustrated in FIGS. 9C and 9D.

Although the coordinate positions of the circles in the front-face and the back-face are inherently deviated as illustrated in FIG. 9C, by correcting the deviation of Δx and Δy, the coordinate positions with respect to the circle 901 coincide as illustrated in FIG. 9D. Subsequently, similarly, a display of the area around the circle 902 as a center is performed by using the key 604 for enlargement and reduction and the scroll bars 606 and 607. A coordinate position in the landscape direction of the center at this time is held as x2.

When the magnifications in the landscape direction of the front-face and the back-face do not coincide, even if the coordinates of the circle 901 are made coincident, such a guarantee that the coordinate positions of the circle 902 coincide is not obtained. Therefore, the positional deviation of the circle 902 is adjusted again by using the key 603 for adjusting the coordinate position. Thus, Δx is obtained for the circle 902 and the magnification sx is obtained from Δx, the coordinate position x1 in the landscape direction of the circle 901, and the coordinate position x2 in the landscape direction of the circle 902.

Specifically speaking, since it is necessary to enlarge a length of (x2−x1−Δx) to (x2−x1), sx=(x2−x1)/(x2−x1−Δx). Such a state is illustrated in FIGS. 9D and 9E.

As illustrated in FIG. 9D, although the positions of the circle 901 coincide, the positions of the circle 902 do not coincide. Therefore, a deviation quantity of the circle 902 is obtained again. In this case, the back-face image itself is not shifted but by changing the magnification of the back-face image, the positions in the front-face image and the back-face image of any of the circles coincide as illustrated in FIG. 9E. Although only the registration in the landscape direction has been described here, the magnification sy in the portrait direction can be also similarly obtained.

As mentioned above, in the embodiment, as proper setting values to eliminate the show-through image, besides the setting values described in the foregoing embodiment, by obtaining the values of the magnifications sx and sy of the back-face image and executing the magnification changing process, a fine change of the size of back-face image is absorbed and can be eliminated at a higher precision. The image data subjected to the image processes by using the optimum setting values obtained in this manner can be printed out by the image outputting unit 105 or transmitted to the network.

Although the embodiment has been described with respect to the construction in which the magnification of the front-face and that of the back-face are made coincident by using the displaying unit, besides the magnifications of the front-face and the back-face, the invention can be also applied to another geometrical transformation such as distortion, skew, inclination, or the like. Also in this case, they can be also calculated from results of the registration of a plurality of points.

### Third Embodiment

In the foregoing first and second embodiments, when the show-through image is eliminated, the front-face image and the back-face image are temporarily stored into the storing apparatus and, thereafter, the processes are started. While the operation to obtain the optimum setting values is being executed, the repetitive process using the stored image data is necessary. However, such an operation that when a plurality of pages are continuously processed after the setting values were decided, the intermediate image before the elimination of the show-through image is stored on a page unit basis is a redundant process.

When considering the subsequent use, it inherently ought to be sufficient if only the image data suitable for an output in which the show-through image has been eliminated was stored. Therefore, the embodiment will be described with respect to a construction in which the show-through image is eliminated while minimizing a storage quantity of the image data.

Since a construction of the apparatus using FIGS. 1, 2, and 3 in the third embodiment is also similar to that of the first embodiment, its description is omitted.

In the construction of the image processing apparatus illustrated in FIG. 1, when the front-face image of the original is obtained and when the back-face image is obtained, the same reading unit 209 is used. Therefore, if the front-face image is not obtained yet, the back-face image cannot be obtained. Thus, if the front-face image is not completely stored, the show-through image eliminating process cannot be executed by using the back-face image.

However, in the case of the construction of the image processing apparatus illustrated in FIG. 2, since the front-face image is obtained by using the reading unit 209 and the back-face image is obtained by using the reading unit 304, the image data can be simultaneously read. In the reading apparatus in this embodiment, the construction of FIG. 2 is presumed and a construction in which the front-face image and the back-face image can be simultaneously obtained by the different reading units is used as a prerequisite.

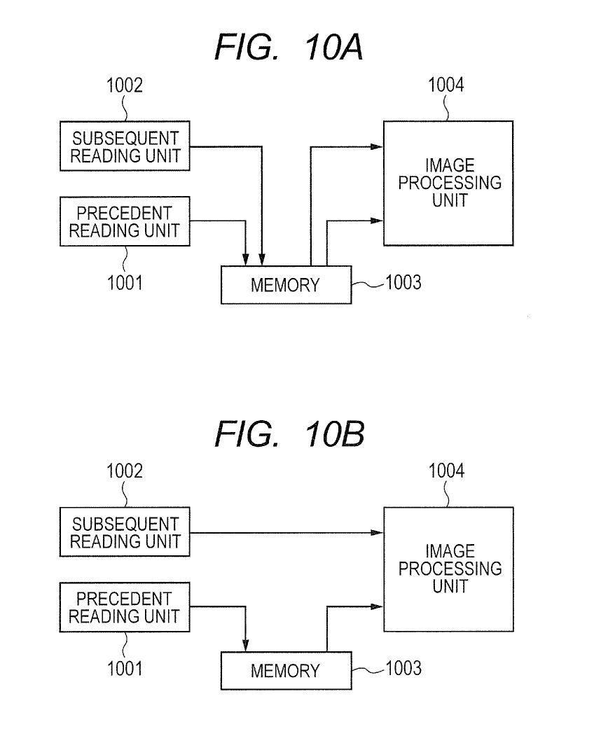

FIGS. 10A and 10B are block diagrams for describing the construction of the image processing apparatus illustrating the embodiment.

In FIG. 10A, a precedent reading unit 1001 writes the image data of the original which is read by the reading unit 209 illustrated in FIG. 2 into a memory 1003 and stores therein. A subsequent reading unit 1002 writes the image data which is read by the reading unit 304 illustrated in FIG. 2 into the memory 1003 and stores therein. A description will be made on the assumption that the image data from the precedent reading unit 1001 is the front-face image data and the image data from the subsequent reading unit 1002 is the back-face image data.

First, with respect to the calculation of the setting values which are used in the various kinds of show-through image elimination described by using FIG. 6 shown in the foregoing first embodiment, both of the front-face image data and the back-face image data are temporarily stored into the memory 1003 as illustrated in FIG. 10A. Thus, when the operation result in the operation unit 107 is displayed to the displaying unit 106, the show-through image eliminating process which is executed by an image processing unit 1004 is realized at a high speed on the basis of the image data stored in the memory 1003 corresponding to the storing unit 103 without executing the reading operation by the apparatus.

By the above-described construction, when the processes are executed to a plurality of subsequent originals on the basis of various kinds of decided setting values, as illustrated in FIG. 10B, the data of only a certain partial width of the image data which was read by the precedent reading unit 1001 is stored in the memory 1003, thereby reducing a storing time and a capacity of the memory. That is, the image process is executed in a real-time manner while reading the original by the reading apparatus and the processed image data in which the show-through image has been eliminated is stored and output. The memory 1003 is a unit for storing the image data which is read by the first reading unit and is constructed in such a manner that the front-face image data of an amount corresponding to the image width which is decided in accordance with a distance between the first and second reading units which are arranged can be stored.

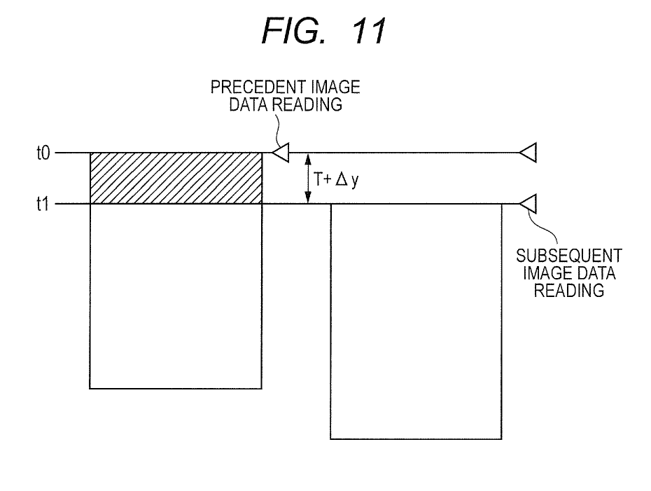

The image width of the image data which is stored in the memory 1003 will be described with reference to FIG. 11.

FIG. 11 is a diagram for describing the image process of the image processing apparatus showing the embodiment.

In FIG. 11, the reading of the image data from the precedent reading unit 1001 is started at certain time to. However, since the original does not reach the subsequent reading unit 1002 yet at that time, the information of the back-face at a front edge of the precedent reading unit 1001 is not obtained, so that the show-through image eliminating process cannot be executed. Therefore, for a period of time until the original reaches a front edge of the subsequent reading unit 1002, the CPU 104 allows the image data read by the precedent reading unit 1001 to be stored in the memory 1003.

After time t1, as image data which was precedently read, the data which is read out of the memory 1003 is used and as subsequent image data, the image data which was read is used, so that the same position of the front-face and the back-face can be referred to and the show-through image eliminating process can be executed.

For such a period of time between t1 and t0, even if a quantity of image data of the image width to be read reaches a memory quantity of the data which has to be stored in the memory 1003 and the process progresses, such a width is not changed so long as the precedent image and the subsequent image are read at the same speed.

Therefore, at a point of time when the subsequent image has been read, the memory 1003 in which the precedent image of the width which was read has been written may be overwritten and this memory can be constructed as a ring buffer of a band unit.

As for the image width to be read for the period of time between t1 and t0, now assuming that a physical distance between the reading units 209 and 304 of the reading apparatus is equal to T, the distance T is inherently equal to the image width. However, a value of the width is not constant but is deviated by a distance of a few pixels due to an assembling crossover. Such a deviation can be absorbed by Δy obtained by the adjustment using the key 603 in FIG. 6 described in the foregoing first embodiment.

A value obtained by adding Δy to the physical distance between the reading units is the minimum memory size adapted to simultaneously process the front-face and the back-face. The memory size is calculated on the basis of Δy and the show-through image eliminating process can be executed in a real-time manner.

For example, if the physical distance between the reading units 209 and 304 is equal to 1 inch, a reading resolution is equal to 600 dpi (dots per inch), and a value of Δy is equal to +3, it is sufficient to store the image data of 603 lines into the memory 1003.

Although the embodiment has been described on the assumption that the size of memory 1003 is calculated on the basis of Δy, if a sufficient memory size can be provided, reading timing of the memory is controlled on the basis of Δy.

That is, it is necessary to read out the data from the memory 1003 at the timing when the subsequent image has been read at the position that is deviated by Δy for the width which can be read for the period of time between t1 and t0. According to the foregoing example, the image data is read out of the memory 1003 at the timing when the image data of 603 lines has been read by the precedent reading unit 1001 and is synchronized with the image data read by the subsequent reading unit 1002, thereby enabling the registration of the front-face image and the back-face image to be performed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-262211, filed Nov. 30, 2011, which is hereby incorporated by reference herein in its entirety.

What is claimed is:

1. An image processing apparatus comprising:
a first reading unit configured to read a first face of an original and generate first image data;
a second reading unit configured to read a second face of the original and generate second image data;
a receiving unit configured to receive an input of a user of an image processing parameter for eliminating an image regarding the second face from the first image data; and
an image processing unit configured to execute an image process for eliminating the image regarding the second face from the first image data on the basis of the image processing parameter received by the receiving unit and the second image data.

2. An apparatus according to claim 1, wherein
the image processing unit makes a coordinate position of the first image data and a coordinate position of the second image data coincide and, thereafter, executes an image process for eliminating the image regarding the second face from the first image data, and
the image processing parameter is a parameter regarding the coordinate position.

3. An apparatus according to claim 1, further comprising a displaying unit configured to display the first image data, and
wherein when the image process has been executed by the image processing unit, the displaying unit displays the first image data to which the image process was executed.

4. An apparatus according to claim 3, wherein the displaying unit further displays the image processing parameter together with the first image data.

5. An apparatus according to claim 1, further comprising a printing unit configured to print the first image data or the first image data to which the image process was executed.

6. An apparatus according to claim 1, wherein the image processing parameter further includes a parameter for eliminating a ground color of the original.

7. An apparatus according to claim 1, further comprising a storing unit configured to store the first image data corresponding to a portion where the first reading unit read the original precedently to the second reading unit.

8. An image processing method comprising:
a first reading step of reading a first face of an original and generating first image data;
a second reading step of reading a second face of the original and generating second image data;
a receiving step of receiving an input of a user of an image processing parameter for eliminating an image regarding the second face from the first image data; and
an image processing step of executing an image process for eliminating the image regarding the second face from the first image data on the basis of the image processing parameter received by the receiving step and the second image data.

9. A storage medium for storing a program for allowing a computer to execute the image processing method according to claim 8.
